(19) United States
(12) Patent Application Publication
(10) Pub. No.: US 2012/0237315 A1
(43) Pub. Date: Sep. 20, 2012

(54) FLOATING FASTENER

(76) Inventor: Ming-Chung CHIU, New Taipei City (TW)

(21) Appl. No.: 13/050,402

(22) Filed: Mar. 17, 2011

(51) Int. Cl. F16B 39/22; F16B 37/06

(52) U.S. Cl. 411/171; 411/166

(57) ABSTRACT

A floating fastener includes a mounting socket defining therein an annular locating groove, a locking member having a head, a shank and a retaining portion located on the periphery of the shank, a spring member sleeved onto the shank of the locking member and stopped between the head of the locking member and a shoulder in the mounting socket, a cap member affixed to the head of the locking member and axially slidable coupled to the mounting socket, and a locating ring mounted in the annular locating groove of the mounting socket for engagement with the retaining portion of the locking member to prohibit the locking member from floating when bonding the mounting socket to a predetermined metal plate member.

### BACKGROUND OF THE INVENTION

1. Field of the Invention

The present invention relates to fasteners for joining metal plate members and more particularly, to a floating fastener, which uses a locating ring to temporarily secure the locking member in position, prohibiting the locking member from floating during bonding of the mounting socket thereof to a predetermined metal plate member.

2. Description of the Related Art

When fastening plate members together, positioning screws that are each formed of a knob, a ring and a screw nail are usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. However, during a mounting or dismounting operation, the screw nails may be lost accidentally, causing installation problems.

To facilitate detachable installation and to avoid missing component parts, floating captive screws are created. FIG. 10 illustrates a floating captive screw according to the prior art. According to this design, the floating captive screw comprises a mounting socket A, a lock screw B floating in the mounting socket A, a spring member A1 sleeved onto the lock screw B and stopped between a mounting flange A2 around the periphery of the mounting socket A and a head B1 of the lock screw B, a stop member A3 mounted inside the mounting socket A, and a screw nut C threaded onto a threaded shank B2 of the lock screw B after insertion of the threaded shank B2 of the lock screw B through the stop member A3 and a inside chamber A0 of the mounting socket A. Further, the mounting socket A has a bottom bonding end A4 for bonding to a plate member D.

This design of floating captive screw is still not satisfactory in function, and has drawbacks as follows:

1. The lock screw B is supported on the spring member A1 and floating in the mounting socket A. When bonding the bottom bonding end A4 of the mounting socket A to the plate member D, the lock screw B may vibrate to interfere with the bonding operation, and the mounting socket A may be not bonded to the plate member D accurately in position, affecting further installation of the screw nut C.

2. The bottom bonding end A4 of the mounting socket A is not deeply inserted into the mounting though hole on the plate member D for bonding. When fastening or unfastening the lock screw B, the mounting socket A may be vibrated and forced away from the plate member D accidentally.

Therefore, it is desirable to provide a floating fastener that eliminates the unstable bonding drawback of the aforesaid prior art design.

### SUMMARY OF THE INVENTION

The present invention has been accomplished under the circumstances in view. It is therefore an object of the present invention to provide a floating fastener, which prohibits the locking member thereof from floating when bonding the mounting socket thereof to a predetermined metal plate member, facilitating installation.

To achieve this and other objects of the present invention, a floating fastener is provided for bonding to a first metal plate member for detachably fastening said first metal plate member to a second metal plate member. The floating fastener comprises a mounting socket, a locking member, a spring member, a cap member and a locating ring. The mounting socket comprises an open chamber, an annular locating groove defined in the open chamber, a shoulder defined in the open chamber above the annular locating groove, a rim extending around the periphery of the top side thereof and a bottom mounting portion located on the bottom side thereof for bonding to a mounting through hole of the first plate member. The locking member is floatable in the mounting socket and adapted for fastening to a mounting hole on the second metal plate member to lock the first metal plate member to the second metal plate member, comprising a head and a shank perpendicularly downwardly extended from the center of the bottom wall of the head. The shank comprises a retaining portion extending around the periphery thereof, and terminates in a fastening end piece. The spring member is sleeved onto the shank of the locking member and stopped between the head of the locking member and the shoulder of the mounting socket. The cap member is affixed to the head of the locking member and axially slidably coupled to the periphery of the mounting socket and stoppable at the bottom side of the rim of the mounting socket. The locating ring is mounted in the annular locating groove in the open chamber of the mounting socket, defining therein a retaining hole for temporarily securing the retaining portion of the locking member to prohibit the locking member from floating during bonding of the mounting socket to the first metal plate member.

Further, the retaining portion of the locking member is peripherally embossed to provide a pattern of fine teeth, ribs or raised portions in a regular or irregular array for engagement with the retaining hole of the locating ring.

### BRIEF DESCRIPTION OF THE DRAWINGS

FIG. 1 is an oblique top elevation of a floating fastener in accordance with a first embodiment of the present invention.

FIG. 2 is an exploded view of the floating fastener in accordance with the first embodiment of the present invention.

FIG. 3 is a sectional side view of FIG. 2.

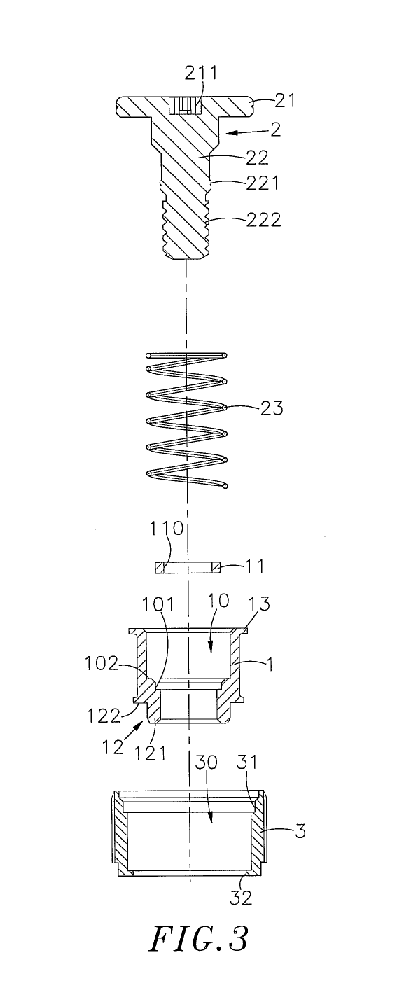

FIG. 4 is a sectional assembly view of the first embodiment of the present invention before installation of the floating fastener in a first metal plate member.

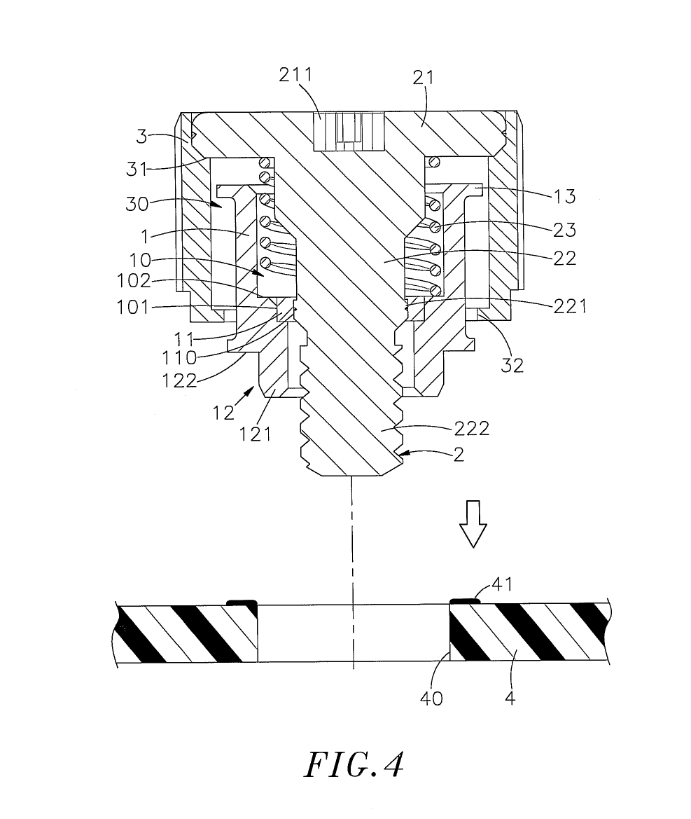

FIG. 5 is a schematic sectional view of the first embodiment of the present invention, illustrating the floating fastener bonded to the first metal plate member.

FIG. 6 is a schematic sectional view of the first embodiment of the present invention, illustrating the retaining portion of the shank of the locking member disengaged from the locating ring after the floating fastener bonded to a first metal plate member.

FIG. 7 corresponds to FIG. 6, illustrating the spring member released and the shank of the locking member retracted into the inside of the mounting socket before attachment of the first metal plate member to a second metal plate member.

FIG. 8 corresponds to FIG. 7, illustrating the fastening end piece of the locking member fastened to the mounting hole of the second metal plate member.

FIG. 9 is an exploded view of a floating fastener in accordance with a second embodiment of the present invention.

FIG. 10 is a sectional view of a floating captive screw according to the prior art.

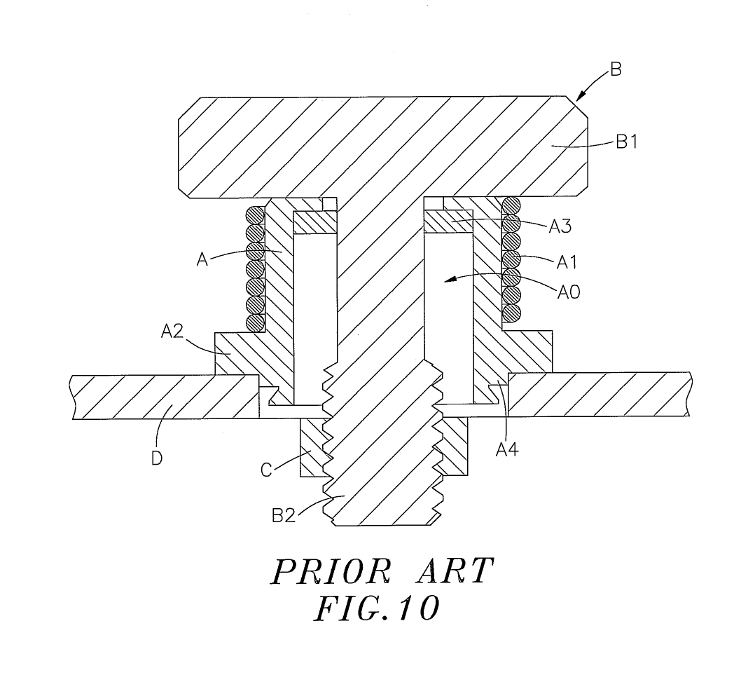

### DETAILED DESCRIPTION OF THE PREFERRED EMBODIMENT

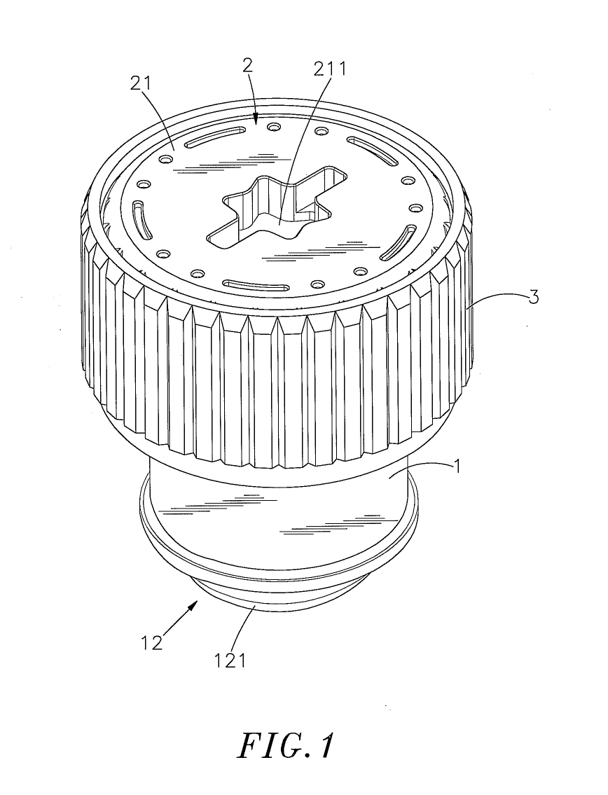

Referring to FIGS. 1˜4, a floating fastener in accordance with a first embodiment of the present invention is shown comprising a mounting socket 1, a locking member 2, a locating ring 11, a spring member 23 and a cap member 3.

The mounting socket 1 comprises an open chamber 10, an annular locating groove 101 defined in a reduced bottom side of the open chamber 10, a shoulder 102 defined in the open chamber 10 above the annular locating groove 101, a bottom mounting portion 12 that defines a horizontally extending upper bonding face 122 and a vertically extending lower mounting neck 121, and a rim 13 extending around the periphery of the top side thereof.

The locating ring 11 is mounted in the annular locating groove 101 in the open chamber 10 of the mounting socket 1, defining therein a retaining hole 110.

The locking member 2 comprises a head 21, a tool-driving device 211 located on the top wall of the head 21, and a shank 22 perpendicularly downwardly extended from the center of the bottom wall of the head 21. The shank 22 comprises a retaining portion 221 extending around the periphery thereof and terminates in a fastening end piece 222.

The spring member 23 is sleeved onto the shank 22 of the locking member 2 and stopped against the head 21 of the locking member 2.

The cap member 3 defines therein an open space 30 that extends through opposing top and bottom sides of the cap member 3, a locating groove 31 extending around the inside wall thereof at a top side in the open space 30 and an annular inside bottom flange 32 extending around the inside wall thereof at a bottom side in the open space 30.

When assembling the component parts of the floating fastener, insert the shank 22 of the locking member 2 into the retaining hole 110 of the locating ring 11 in the annular locating groove 101 inside the open chamber 10 of the mounting socket 1 to position the retaining portion 221 of the locking member 2 in the locating ring 11 temporarily and to let the spring member 23 be compressed between the head 21 of the locking member 2 and the shoulder 102 of the mounting socket 1. At this time, the floating end piece 222 of the locking member 2 extends out of the bottom mounting portion 12 of the mounting socket 1. Thereafter, insert the mounting socket 1 downwardly into the open space 30 of the cap member 3 to force the head 21 of the locking member 2 into friction engagement with the locating groove 31 of the cap member 3 positively. At this time, the horizontally extending upper bonding face 122 of the bottom mounting portion 12 of the mounting socket 1 is moved downwardly over the annular inside bottom flange 32 of the cap member 3, and the rim 13 of the mounting socket 1 suspends in the open space 30 above the annular inside bottom flange 32 of the cap member 3. Thus, the mounting socket 1, the locking member 2, the locating ring 11, the spring member 23 and the cap member 3 are assembled.

Further, the tool-driving device 211 at the head 21 of the locking member 2 can be a Phillips groove, keystone groove, asterisk groove, hex groove, or any other design of tool groove for driving by a hand tool 212 (that can be a Phillips-tip screwdriver, keystone-tip screwdriver, asterisk-tip screwdriver, hex-tip screwdriver, or any other design of tool matching the tool-driving device 211). Further, the retaining portion 221 of the shank 22 of the locking member 2 has an outer diameter relatively greater than the outer diameter of the shank 22 and the inner diameter of the retaining hole 110 of the locating ring 11. Further, the retaining portion 221 can be embossed, or made to provide fine teeth, ribs or raised portions in a regular or irregular array. Thus, the retaining portion 221 of the shank 22 of the locking member 2 can be positively and temporarily secured to the retaining hole 110 of the locating ring 11.

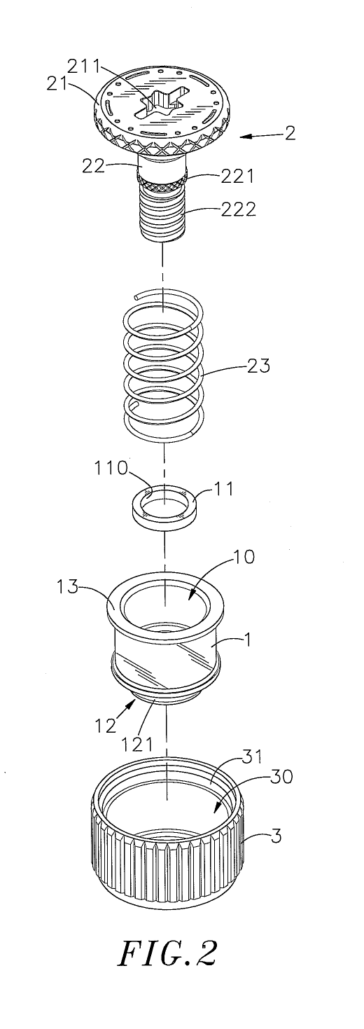

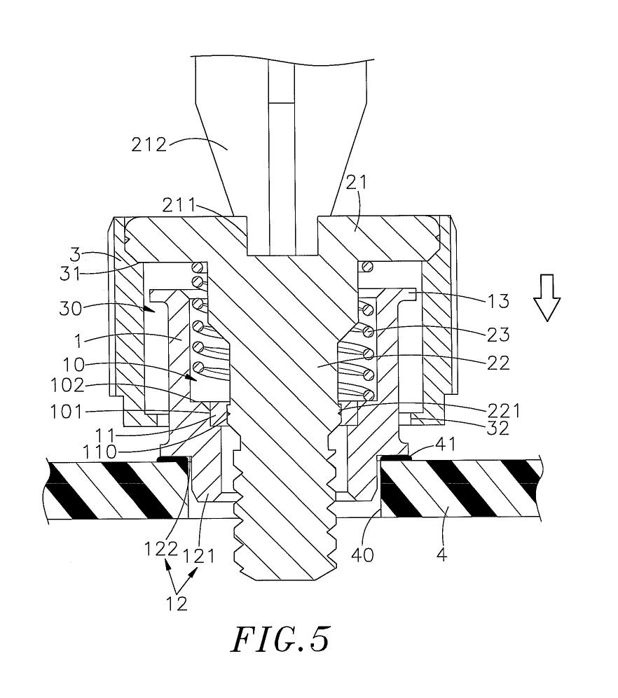

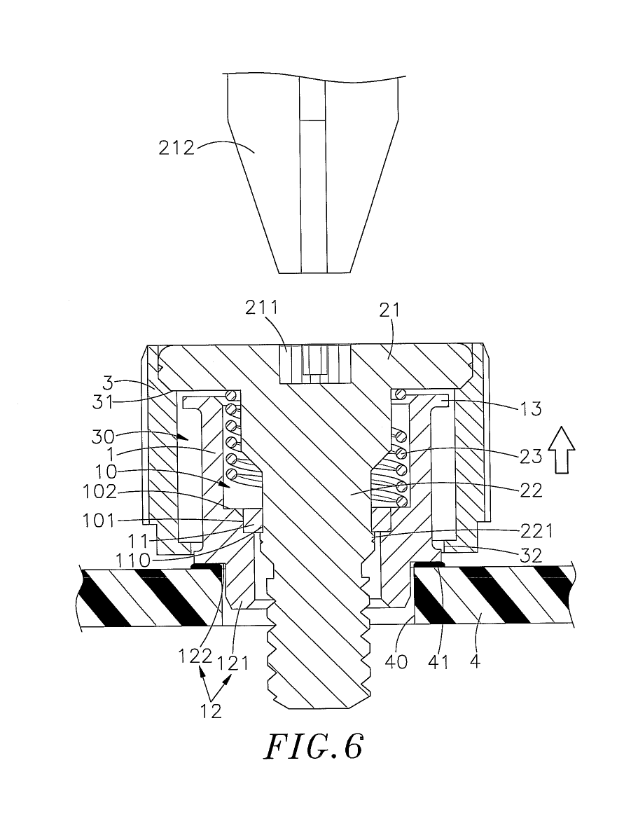

Referring to FIGS. 5 and 6 and FIGS. 2˜4 again, when the floating fastener is assembled, the retaining portion 221 of the shank 22 of the locking member 2 is temporarily secured to the retaining hole 110 of the locating ring 11 in the mounting socket 1, and the fastening end piece 222 of the shank 22 of the locking member 2 is suspending outside the mounting socket 1. During installation, insert the vertically extending lower mounting neck 121 of the bottom mounting portion 12 of the mounting socket 1 into a mounting through hole 40 of a first metal plate member 4 and stop the horizontally extending upper bonding face 122 of the bottom mounting portion 12 of the mounting socket 1 against an applied solder paste 41 at the top surface of the first metal plate member 4 around the mounting through hole 40, and then apply a bonding technique (reflow soldering or spot welding technique) to fixedly fasten the mounting socket 1 to the first metal plate member 4. After the mounting socket 1 is affixed to the first metal plate member 4, use the hand tool 212 to drive the tool-driving device 211 of the head 21 of the locking member 2, moving the locking member 2 downwards relative to the mounting socket 1 and the first metal plate member 4 and disengaging the retaining portion 221 of the shank 22 from the retaining hole 110 of the locating ring 11, enabling the locking member 2 to be pushed upwardly outwards relative to the mounting socket 1 by the spring member 23 to let the annular inside bottom flange 32 of the cap member 3 be stopped at the bottom side of the rim 13 of the mounting socket 1. Thus, the locking member 2 is floating in the mounting socket 1.

As stated above, the retaining portion 221 of the shank 22 of the locking member 2 can be temporarily secured to the locating ring 11 in the mounting socket 1 to keep the spring member 23 in a compressed condition in the mounting socket 1, facilitating bonding the bottom mounting portion 12 of the mounting socket 1 to the mounting through hole 40 of the first metal plate member 4 and avoiding vibration of the locking member 2 during the bonding process.

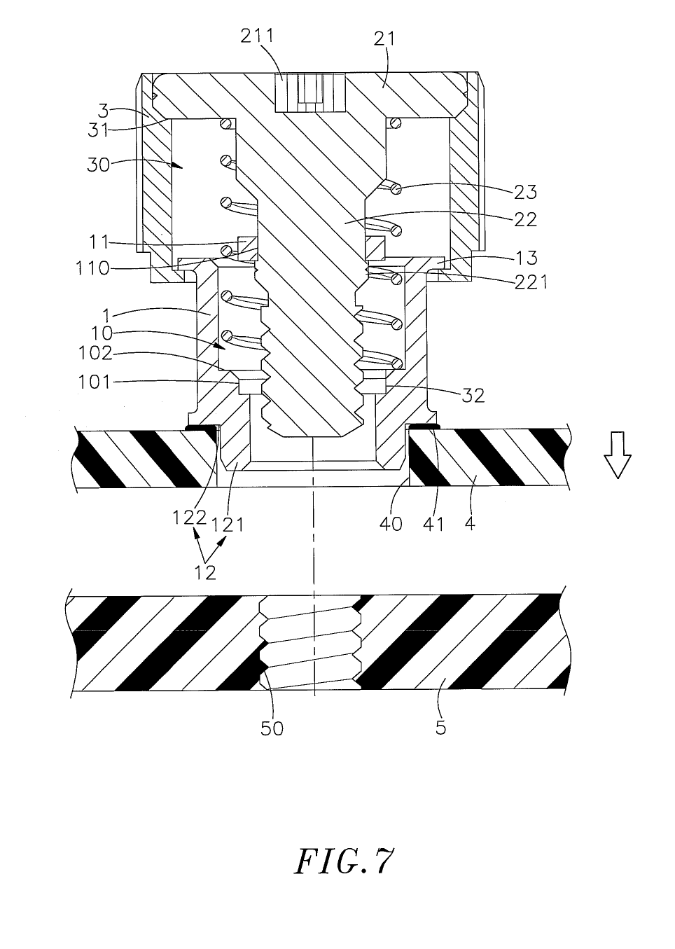

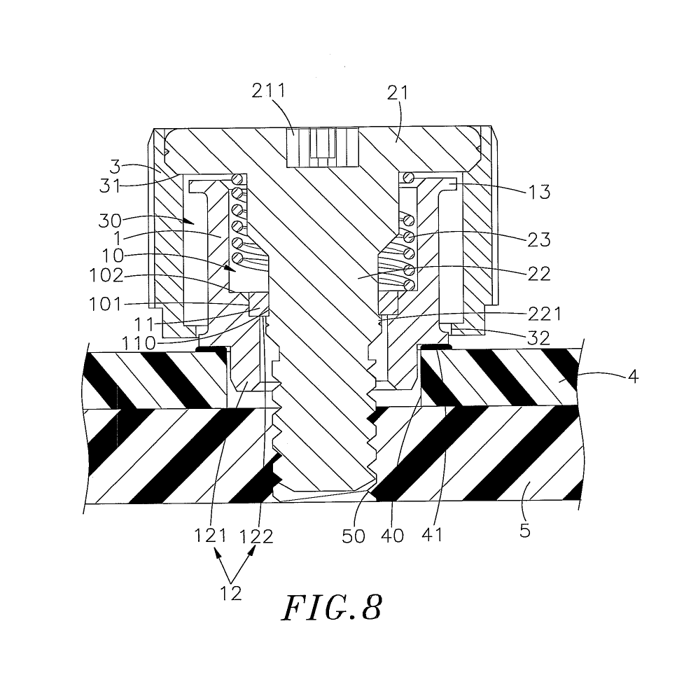

Referring to FIGS. 7 and 8, after installation of the floating fastener in the first metal plate member 4, the first metal plate member 4 can be attached to a second metal plate member 5 and locked thereto by the floating fastener. When the first metal plate member 4 is attached to the second metal plate member 5, the mounting through hole 40 of the first metal plate member 4 is kept in axial alignment with a mounting hole 50 on the second metal plate member 5, and then the locking member 2 is operated to drive the fastening end piece 222 of the shank 22 of the locking member 2 into the mounting hole 50, thereby locking the first metal plate member 4 to the second metal plate member 5.

Further, the fastening end piece 222 of the locking member 2 can be a lock screw or lock pin matching the mounting hole 50.

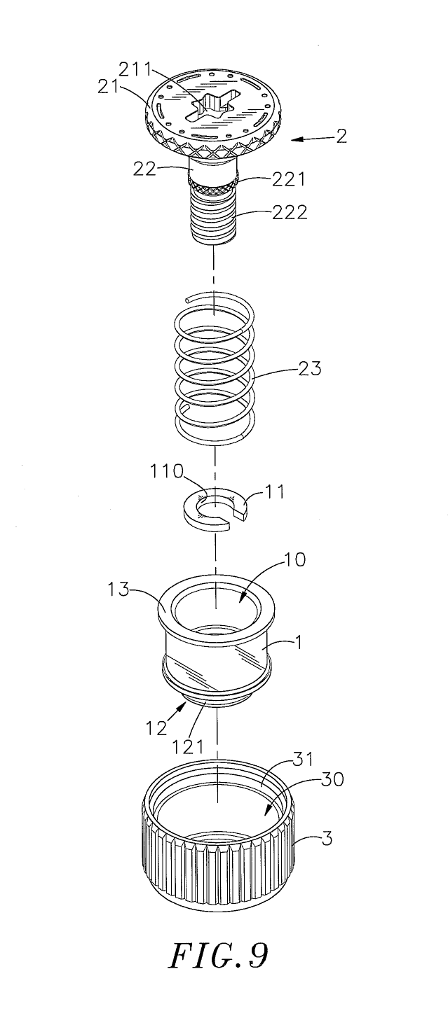

FIG. 9 illustrates a floating fastener in accordance with a second embodiment of the present invention. This second embodiment is substantially similar to the aforesaid first embodiment with the exception of the locating ring 11. In the aforesaid first embodiment, the locating ring 11 is an annular ring. According to this second embodiment, the locating ring 11 is a C-shaped retainer.

The above described embodiments are simply examples of the invention but not intended for us as limitations of the invention. In general, the invention provides a floating fastener, which comprises a mounting socket 1, which defines therein an open chamber 10 and an annular locating groove 101 in the open chamber 10, a locking member 2 having a head 21 and a shank 22 that defines a retaining portion 221 and a mounting end piece 222, a spring member 23 sleeved onto the shank 22 of the locking member 2 and stopped between the head 21 of the locking member 2 and a shoulder 102 in the mounting socket 1, a cap member 3 fastened to the head 21 of the locking member 2 and axially slidable coupled to the mounting socket 1, and a locating ring 11 mounted in the annular locating groove 101 in the open chamber 10 of the mounting socket 1 for engagement with the retaining portion 221 of the locking member 2 to temporarily secure the locking member 2 in a received position and to keep the spring member 23 in a compressed condition, avoiding floating of the locking member and the cap member 3 when bonding the mounting socket 1 to a predetermined metal plate member 4.

In actual application, the floating fastener has the advantages as follows:
1. By means of using locating ring 11 to temporarily secure the locking member 2 in the mounting socket 1 in a received position and to keep the spring member 23 in a compressed condition, the locking member 2 and the cap member 3 are prohibited from floating when bonding the mounting socket 1 to the first metal plate member 4.
2. By means of inserting the vertically extending lower mounting neck 121 of the bottom mounting portion 12 of the mounting socket 1 into the mounting through hole 40 of the first metal plate member 4 and stopping the horizontally extending upper bonding face 122 of the bottom mounting portion 12 at the applied solder paste 41 at the top surface of the first metal plate member 4 around the mounting through hole 40, the mounting socket 1 can then be positively and accurately bonded to the first metal plate member 4 by a bonding technique (reflow soldering or spot welding technique) without vibration. After the mounting socket 1 is bonded to the first metal plate member 4, the first metal plate member 4 can be detachably fastened to the second metal plate member 5 by the locking member 2.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A floating fastener mounted in a first metal plate member for detachably fastening said first metal plate member to a second metal plate member, comprising:
a mounting socket comprising an open chamber, an annular locating groove defined in said open chamber, a shoulder defined in said open chamber above said annular locating groove, a rim extending around the periphery of a top side thereof and a bottom mounting portion located on a bottom side thereof for bonding to a mounting through hole of said first plate member;
a locking member floatable in said mounting socket and adapted for fastening to a mounting hole on said second metal plate member to lock said first metal plate member to said second metal plate member, said locking member comprising a head and a shank perpendicularly downwardly extended from the center of a bottom wall of said head, said shank comprising a retaining portion extending around the periphery thereof and being terminated in a fastening end piece;
a spring member sleeved onto said shank of said locking member and stopped between said head of said locking member and said shoulder of said mounting socket;
a cap member affixed to said head of said locking member and axially slidably coupled to the periphery of said mounting socket; and
a locating ring mounted in said annular locating groove in said open chamber of said mounting socket and defining therein a retaining hole for temporarily securing said retaining portion of said locking member to prohibit said locking member from floating in said mounting socket.

2. The floating fastener as claimed in claim 1, wherein said annular locating groove is defined in a reduced bottom side of said open chamber.

3. The floating fastener as claimed in claim 2, wherein said bottom mounting portion of said mounting socket defines a horizontally extending upper bonding face for bonding to a top wall of said first metal plate member with a solder paste and a vertically extending lower mounting neck for engaging into the mounting through hole of said first metal plate.

4. The floating fastener as claimed in claim 1, wherein said retaining portion of said locking member is peripherally embossed to provide a pattern of fine teeth, ribs or raised portions in a regular or irregular array.

5. The floating fastener as claimed in claim 4, wherein said retaining portion of said locking member has an outer diameter greater than the outer diameter of said shank.

6. The floating fastener as claimed in claim 1, wherein said cap member defines therein an open space for the passing of the shank of said locking member, a locating groove extending around an inside wall thereof at a top side in said open space and fixedly fastened to the periphery of the head of said locking member and an annular inside bottom flange extending around the inside wall thereof at a bottom side in said open space and slidably coupled to the periphery of said mounting socket and stoppable at a bottom side of said rim of said mounting socket.
